(19) United States
(12) Patent Application Publication
(10) Pub. No.: US 2009/0082948 A1
(43) Pub. Date: Mar. 26, 2009

(54) TRAFFIC INCIDENT DETECTION SYSTEM

(75) Inventors: Tomoaki HIRUTA, Hitachi (JP); Masatoshi Kumagai, Hitachi (JP); Koichiro Tanikoshi, Hitachinaka (JP); Takayoshi Yokota, Hitachiota (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 12/179,246

(22) Filed: Jul. 24, 2008

(30) Foreign Application Priority Data
Jul. 25, 2007 (JP) 2007-192757

(51) Int. Cl. G08G 1/00

(52) U.S. Cl. 701/117

(57) ABSTRACT

An object of the present invention is to provide a traffic information system that detects an unexpected incident such as a traffic accident or construction work from traffic information about surrounding road links. Historical traffic information is used to perform component analysis for a group of links that are targets of unexpected incident detection, and recovered traffic information for the historical traffic information is determined from computed top bases of the traffic information about the group of links. Difference statistical traffic information is generated from the difference between the historical traffic information and its recovered traffic information. For real-time traffic information, recovered traffic information for the real-time traffic information is determined from the top bases. The difference between the real-time traffic information and the recovered traffic information is compared with the difference statistical traffic information, and if the difference of the real-time traffic information is larger, the occurrence of an unexpected incident is determined.

### BACKGROUND OF THE INVENTION

1. Field of the Invention

The present invention relates to a traffic information system that provides traffic information such as road congestion information.

2. Background Art

Among conventional traffic information systems, a service like VICS (registered trademark) is known in which traffic information such as about traffic congestion is collected via infrared sensors or optical beacons placed at roadsides, and provided to on-board devices (e.g., car navigation systems, car televisions, and teletext broadcast receivers) via FM multiplex broadcast or via facilities such as optical beacons or radio wave beacons placed at roadsides.

Further, in recent years, a probe traffic information service has been drawing attention in which traffic information is collected by vehicles serving as sensors in themselves and provided to on-board devices. In this system, the vehicles collect historical data (probe information) such as driving position information and time information, and uplink the information to a traffic information center via a communication device such as a mobile phone or radio set. Such vehicles are called floating cars. The traffic information center converts the probe information collected from each vehicle into traffic information about links and provides it to each on-board device via a communication device.

The above conventional techniques provide congestion prediction information based on real time trafic information such as about congestion (e.g., information that a certain road is congested, congestion is occurring for certain kilometers, and so on) and historical data. The probe traffic information has a spatial lack because driving positions and timings of the floating cars are random. Since the lack in the traffic information prevents proper processing in the use such as information display on an on-board device or route search, the missing data needs to be spatially complemented. The probe traffic information service provides traffic information including the complemented traffic information.

However, considering the actual road traffic, there are many traffic impediments caused by small accidents that cannot clearly represent the road situation and by broken-down vehicles. Drivers have not been sufficiently informed of such traffic impediments due to unexpected incidents as “unexpected-incident impediments”.

In this respect, JP Patent Publication (Kokai) No. 2005-285108A discloses a method of comparing historical traffic information with real-time traffic information and, based on whether the deviation exceeds a threshold, detecting the occurrence of an unexpected incident. In this approach, the detection is performed on a road link basis, and the range of the threshold for the deviation between the historical traffic information and the real-time traffic information is set on a time-of-day basis and a location basis.

JP Patent Publication (Kokai) No. 2005-352649A discloses a method of predicting whether congestion due to a traffic accident is occurring on a road link on which a traffic accident occurred in the past. In this approach, a traffic accident location is extracted from accumulated traffic information, and a time-series variation of link travel times for road links preceding and succeeding the traffic accident location is generated as accident congestion trend information. Further, link travel times of real-time traffic information are compared with congestion information at normal times to see if a threshold is exceeded. A time-series variation of the link travel times in traffic information from historical traffic information to the latest traffic information is compared with the accident congestion trend information. Thus, it is predicted whether congestion due to a traffic accident is occurring.

JP Patent Publication (Kokai) No. 03-209599A (1991) discloses an apparatus in which upper and lower thresholds for determining an abnormal traffic flow after a predetermined time are set based on a predicted value, and the current traffic state amount is compared with the thresholds to determine the occurrence of an unexpected incident.

JP Patent Publication (Kokai) No. 11-238194A (1999) discloses a system in which information about an unexpected incident such as a traffic accident is collected to predict congestion. In this system, an unexpected incident is collected as a driving driver witnesses the incident, and transmitted from a vehicle to a traffic information center via communication (e.g., via a communication terminal provided in the vehicle or via a mobile phone). To reduce the effort of the reporter, position information about the unexpected incident is obtained by position detection means provided in the vehicle (e.g., a GPS receiver or a direction detector) and transmitted to the traffic information center.

### SUMMARY OF THE INVENTION

In JP Patent Publication (Kokai) No. 2005-285108A, an unexpected incident is determined on a road link basis. Further, while the threshold for the deviation between the real-time traffic information and the statistical traffic information is set on a time-of-day basis and a location basis, this is also set on a road link basis. The relationship with traffic information about surrounding road links is not taken into account. Therefore, even when the overall traffic amount around a road link in question increases, it can be incorrectly determined as an unexpected incident.

In JP Patent Publication (Kokai) No. 2005-352649A, an unexpected incident can only be determined on a road link on which an accident occurred in the past and by an on-board device that stores traffic information data about that accident. This limits the range in which unexpected incidents are determined.

In JP Patent Publication (Kokai) No. 03-209599A (1991), an unexpected incident is detected on a link basis as in JP Patent Publication (Kokai) No. 2005-285108A. Therefore, even when the overall traffic amount around a road link in question increases, it can be incorrectly determined as an unexpected incident.

In JP Patent Publication (Kokai) No. 11-238194A (1999), on each occurrence of an unexpected incident such as a traffic accident, information about the incident is received from a driver who witnessed the scene of the incident via a mobile phone, PHS phone, radio set, or the like. Therefore, recognition of the incident can vary depending on the senses of the reporter, and the provided information may have to be modified.

The present invention provides a traffic information system that detects an unexpected incident such as a traffic accident or construction work without being informed of the unexpected incident by a person who witnessed the scene of the unexpected incident and without detecting the unexpected incident based on analysis of traffic information about only a single link.

To solve the above problems, the present invention includes: a traffic information storage unit that accumulates externally provided traffic information; a statistical computation unit that generates correlation information among road links about traffic information by statistical analysis for historical traffic information stored in the traffic information storage unit; a traffic information reconstruction unit that determines traffic information reconstructed using the generated correlation information so that an error relative to input traffic information is minimized; and a difference computation unit that determines a difference between the provided traffic information and the reconstructed traffic information reconstructed for the provided traffic information.

The traffic information reconstruction unit determines real-time reconstructed traffic information reconstructed for real-time traffic information, and historical reconstructed traffic information reconstructed for historical traffic information. The difference computation unit determines a difference between the real-time traffic information and the real-time reconstructed traffic information, and a difference between the historical traffic information and the historical reconstructed traffic information. An unexpected incident determination unit determines the presence or absence of an unexpected incident for each road link by comparing the difference between the real-time traffic information and the real-time reconstructed traffic information with a threshold defined based on the difference between the historical traffic information and the historical reconstructed traffic information.

According to the present invention, an unexpected incident causing a traffic impediment can be automatically detected from traffic information about road links around a road link on which detection of an unexpected incident is intended.

### BRIEF DESCRIPTION OF THE DRAWINGS

FIG. 1 is a diagram of an overall traffic information system.

FIG. 2 is a diagram showing a structure of a basis storage unit.

FIG. 3 is a diagram showing a processing flow of reconstructing real-time traffic information in online processing.

FIG. 4 is a diagram showing a processing flow of reconstructing historical traffic information in offline processing.

FIG. 5 is a diagram showing an overview of a processing flow in a difference computation unit for the real-time traffic information in online processing.

FIG. 6 is a diagram showing an overview of a processing flow in the difference computation unit for the historical traffic information in offline processing.

FIG. 7 is a diagram showing a structure of difference information stored in a difference information storage unit.

FIG. 8 is a diagram showing an overview of a processing flow in an unexpected incident determination unit.

FIG. 9 is a diagram showing a structure of unexpected incident detection information.

FIG. 10 is a diagram showing an exemplary display of the unexpected incident detection information about an area on an on-board terminal apparatus.

FIG. 11 is a diagram showing a concept of an unexpected incident detected area for a link 1.

### DESCRIPTION OF SYMBOLS

1 center apparatus
10 traffic information reception unit
20 real-time traffic information storage unit
30 historical traffic information storage unit
40 basis computation unit
50 basis storage unit
60 traffic information reconstruction unit
70 difference computation unit
80 difference statistical traffic information storage unit
90 unexpected incident determination unit
100 traffic information transmission unit
110 on-board terminal apparatus

### DETAILED DESCRIPTION OF THE PREFERRED EMBODIMENTS

Embodiments of the present invention will be described with reference to the drawings.

A traffic information system of the present invention is configured on the assumption that real-time traffic information is periodically received. For example, in Japan, travel times corresponding to links receivable from a traffic information center can be considered as the real-time traffic information. A travel time is the time required for driving through a predetermined section. A link is a minimum unit of roads in associating road traffic information with roads. This is also a minimum unit in detecting the travel time, so that a sensor, monitor, or the like is provided between each link in order to measure the travel time. Alternatively, the travel time from one end of a link to the other is detected from driving history data (probe data) collected by a floating car.

### EXAMPLE 1

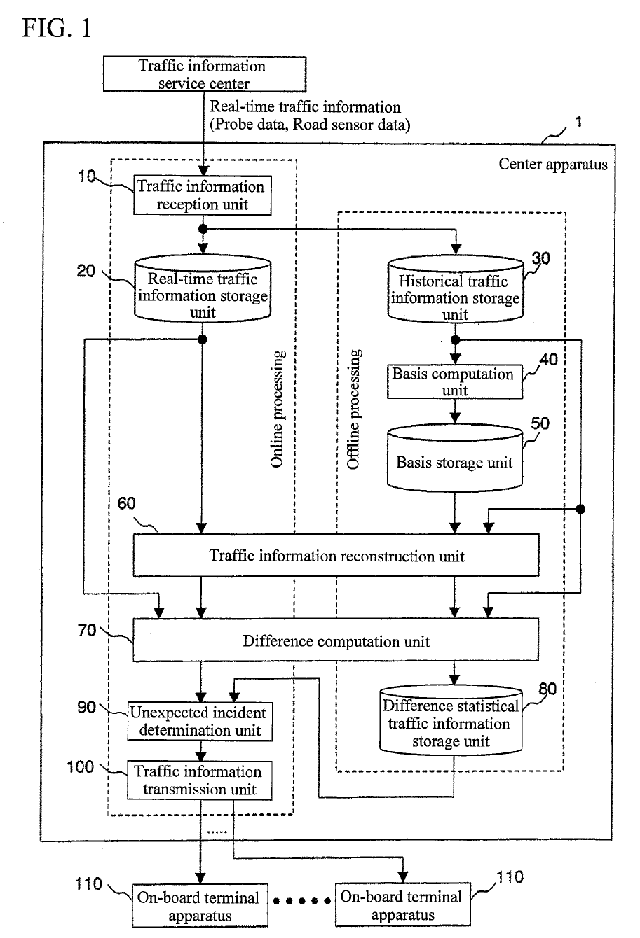

FIG. 1 is a general configuration diagram of the traffic information system according to the present invention. As shown in FIG. 1, the traffic information system consists of a center apparatus 1 and on-board terminal apparatuses 110.

The center apparatus 1 includes functional blocks including a traffic information reception unit 10, a real-time traffic information storage unit 20, a historical traffic information storage unit 30, a basis computation unit 40, a basis storage unit 50, a traffic information reconstruction unit 60, a difference computation unit 70, a difference statistical traffic information storage unit 80, an unexpected incident determination unit 90, and a traffic information transmission unit 100.

The functional blocks in the center apparatus 1 are divided into an offline processing part and an online processing part. Offline processing refers to the historical traffic information storage unit 30, the basis computation unit 40, the traffic information reconstruction unit 60, the difference computation unit 70, and the difference statistical traffic information storage unit 80. Online processing refers to the real-time traffic information storage unit 20, the traffic information reconstruction unit 60, the difference computation unit 70, the unexpected incident determination unit 90, and the traffic information transmission unit 100. The traffic information reconstruction unit 60 and the difference computation unit 70 are functional blocks commonly used in both the offline processing and the online processing.

The center apparatus 1 is implemented as a computer having a storage device, and functions of each functional block constituting the center apparatus 1 are implemented by executing a predetermined program stored in the storage device. The storage device is configured as RAM, nonvolatile memory, a hard disk, or the like.

As the real-time traffic information, the traffic information reception unit 10 receives, from a traffic information service center, the travel time for each link based on data from road sensors placed on links of major roads across the country, or the travel time for each link based on probe data uplinked by floating cars. The real-time traffic information is stored in the real-time traffic information storage unit 20 and the historical traffic information storage unit 30. The information in each storage unit is updated with update cycles of predetermined time intervals. The information in the real-time traffic information storage unit 20 is updated as the traffic information reception unit 10 receives new real-time traffic information. The information in the historical traffic information storage unit 30 is held therein for a long term, for example one month or one year, for use in generating statistical traffic information. However, the real-time traffic information storage unit 20 may accumulate not only traffic information for one update cycle but also traffic information for two or several cycles. The travel time for each link is obtained, for example by measuring the time required for driving from one end of the link to the other with a vehicle detection device placed on each link or by driving a floating car from one end of the data collection target link to the other while measuring the time.

The real-time traffic information storage unit 20 manages real-time traffic information (current-state traffic information) with link IDs of road links for which collection of the information is intended. For example, if the traffic information is received from a road sensor, data such as ID information about a road link, time information about the reception time of a road sensor, the link travel time, the average passing speed determined from the link length and the link travel time, the congestion degree converted from the average passing speed on the road link, and the number of vehicles that passed through the road link is stored in the real-time traffic information storage unit 20. If the traffic information is received from a floating car, data such as the ID of a road link, an ID unique to the floating car, the time of floating into the road link, the time of floating out of the road link, the link travel time, the congestion degree, and the average passing speed is stored.

The historical traffic information storage unit 30 stores traffic information (historical traffic information) previously received by the traffic information reception unit 10. As in the real-time traffic information storage unit 20, this traffic information is managed with link IDs of road links for which collection of the information is intended. For example, if the traffic information has been received from a road sensor, data such as ID information about a road link, time information about the reception time of the road sensor, the link travel time, and the number of vehicles that passed through the road link is stored in the historical traffic information storage unit 30. If the traffic information has been received from a floating car, data such as the ID of a road link, an ID unique to the floating car, the time when the floating car entered the road link, the time when the floating car got out of the road link, and the link travel time is stored.

The basis computation unit 40 divides the traffic information stored in the historical traffic information storage unit 30 into portions for predetermined map areas and performs component analysis for the historical traffic information about a plurality of links included in each area. The basis computation unit 40 then outputs, as bases for the area, components of the traffic information correlatively varying in the group of links in the area.

One sample of data to be analyzed in the component analysis is the traffic information in the historical traffic information storage unit 30 collected at the same timing. The traffic information here represents the congestion degree on each road link, the link travel time, or the average passing speed on the road link. The number of road links to be analyzed corresponds to the number of variables per sample. That is, the historical traffic information collected on M road links at past N collection timings is data with N samples and M variables. Where x(n,m) denotes the traffic information (the congestion degree, link travel time, or average passing speed) about an mth link at a collection timing n, the traffic information about links 1 to M at the collection timing n is represented as a vector X(n)=[x(n,1), x(n,2), . . . , x(n,M)]. Performing the component analysis for such data results in M bases W(1) to W(M). Each basis consists of M elements corresponding to the variables of the original data, and the constituent elements of one basis are components correlatively varying among the variables of the original data. These bases obtained by the component analysis have a nature of approximating any sample of the original data by their linear combination. Where w(p,i) denotes a value representing the intensity of the correlation for a pth basis of an ith link, the pth basis is represented as a vector

W(p)=[w(p,1), w(p,2), . . . , w(p,M)], and

X(n)≈a(n,1)×W(1)+a(n,2)×W(2)+ . . . +a(n,M)×W(M) (Formula 1),

where a(n,p) denotes a weighting coefficient for each basis in the linear combination of the bases.

Another approach to obtaining the bases is to perform component analysis for data that consists of the historical traffic information and statistical traffic information generated from the historical traffic information. In this approach, the weighting coefficient for each basis can be stably obtained because the statistical traffic information with less loss is used to generate the bases. As the statistical traffic information, the average value for each link of the historical traffic information is used. Where the statistical traffic information about the links 1 to M at the collection timing n is represented as a vector T(n)=[t(n,1), t(n,2), . . . , t(n,M)], the statistical value for the link i will be the average value of the traffic information for the link i at collection timings n to (n−k+1), that is,

t(n,i)≈(x(n,i)+ . . . +x(n−k+1,i))/k (Formula 2),

where k denotes the number of samples at the time of generating the statistical traffic information.

The statistical traffic information is generated using the historical traffic information at the same time of day. For example, to obtain the statistical traffic information from 12:00 to 12:30, traffic information at collection timings from 12:00 to 12:30 is extracted from the historical traffic information to generate the statistical traffic information with the averaging processing of Formula 2. The statistical traffic information is generated for each day factor (weekday, holiday, etc.) of the historical traffic information.

The data to be analyzed that consists of the historical traffic information and the statistical traffic information is represented as a vector X2(n)=[X(n), T(n)]=[x(n,1), x(n,2), . . . , x(n,M), t(n,1), t(n,2), . . . , t(n,M)]. The data X2(n) to be analyzed consists of the historical traffic information at a collection timing n and the statistical traffic information at the same collection timing n. This data to be analyzed is data with N samples and 2 M variables, and performing the component analysis for this data to be analyzed results in 2 M bases W′(1) to W′(2 M). Where a pth basis is represented as a vector W′(p)=[w′(p,1), w′(p,2), . . . , w′(p,2 M)], then w′(p,1), . . . , w′(p,M) are components for the historical traffic information correlatively varying among the variables of the original data, and w′(p,M+1), . . . , w′(p,2 M) are components for the statistical traffic information correlatively varying among the variables of the original data. Then, the data X2(n) being analyzed will be

X2(n)≈a′(n,1)×W′(1)+a′(n,2)×W′(2)+ . . .+a′(n,2 M)×W′(2 M) (Formula 3),

where a′(n,p) denotes a weighting coefficient for each basis in the linear combination of the bases.

For the M bases obtained by the component analysis, a variance can be used as an index to represent how much information each basis has. This variance is referred to as a proportion of the basis, and the first to Pth bases in descending order of proportion are collectively defined as top bases. The number of bases P is generally determined from the accumulated proportion, with the number of road links M being the maximum. For example, the number of bases P is determined so that the accumulated proportion is 80% or less. In the description of this example, a group of bases W(1) to W(P) up to the top P (P≦M) whose accumulated proportion is 80% or less are defined as the top bases.

In the above Formula 1, the left-hand side of the equal sign is traffic information (real-time traffic information) at a moment n on a plurality of road link being analyzed, and the right-hand side expresses it as a linear combination of a plurality of bases. In the right-hand side, a basis W(i) corresponds to a component of the traffic information correlatively varying among the links in the area being analyzed. Expressing the traffic information in this manner allows representing the trend of the traffic situation on the links by the magnitude of the coefficient for each basis. While the component analysis is suitable as described above for obtaining such bases by analyzing the historical traffic information, other statistical techniques such as independent component analysis and factor analysis may also be applied.

The purpose of processing by the basis computation unit 40 is to convert the correlation of the traffic information among the links into values as the bases. Therefore, an analysis unit needs to be a group of links correlatively varying in the actual road network. For example, the analysis unit for the component analysis may be link information in the same second-order mesh. The analysis unit is not limited to a second-order mesh unit, but may be any set that consists of a plurality of links. Therefore, it may be applied to mesh units such as a third-order mesh and fourth-order mesh, geographical units such as prefectures, units of road types such as expressways, city expressways, national roads, and general roads, or other combinations. For example, the analysis unit may be a third-order mesh and national roads in Ibaraki prefecture. In this example, M links grouped into a second-order mesh unit will be considered. Since the number of links included in each mesh varies among meshes, the number of grouped links M may not be necessarily the same in each mesh.

Here, a map mesh is a method of partitioning a map like a mesh based on the latitude and longitude. A first-order mesh corresponds to a partition in a 1:200,000 topographic map, which is an area defined by dividing the whole country into square areas of about 80 km per side. A second-order mesh is an area defined by dividing each side of the first-order mesh lengthwise and widthwise into eight equal lengths and corresponds to a partition in a 1:25,000 topographic map. It is mesh data of about 10 km per side with the difference of latitude being 5 minutes and the difference of longitude being 7 minutes and 30 seconds. A third-order mesh is an area defined by dividing each side of the second-order mesh latitudinally and longitudinally into ten equal lengths, which is an area of about 1 km per side with the difference of latitude being 30 seconds and the difference of longitude being 45 seconds.

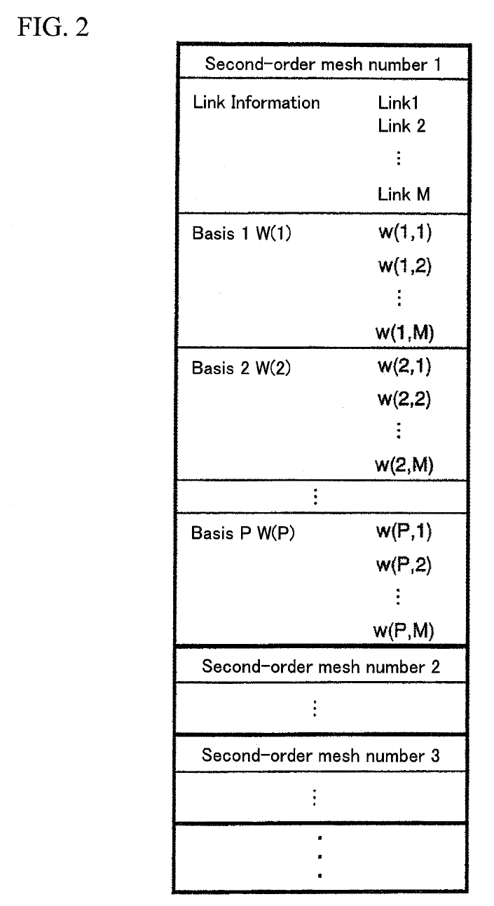

The basis storage unit 50 stores basis information output from the basis computation unit 40. FIG. 2 shows a structure of the basis storage unit 50. For each analysis unit (each second-order mesh unit in this example), the basis storage unit 50 stores information about links (link 1 to link M) analyzed for that analysis unit, and the bases. In an analysis unit, a group of P bases (W(1) to W(P)) output from the basis computation unit 40 and their components (w(1,1) to w(1,M), . . . , w(P,1) to w(P,M)) are stored.

The traffic information reconstruction unit 60 takes, as its input, the traffic information stored in the real-time traffic information storage unit 20 or in the historical traffic information storage unit 30 and the basis information stored in the basis storage unit 50. The traffic information reconstruction unit 60 performs weighted projection of the traffic information onto the bases and, for the projected traffic information, determines the weighting coefficient for each basis. Based on the weighting coefficients and the basis information, reconstructed traffic information data is generated.

A method of computing the reconstructed traffic information will be described. The weighting coefficient for each basis is obtained by performing the weighted projection of the traffic information onto a linear space formed of the top bases W(1), W(2), . . . , W(P) stored in the basis storage unit 50. If the traffic information is collected by floating cars, driving of the floating cars is probabilistic. Therefore, when links for which the traffic information has been measured and links for which the traffic information is missing are known, the weight is set to be 1 for the former and 0 for the latter to determine the coefficient for each basis accounting for the real-time traffic information.

That is, for the traffic information X about the links 1 to M, the traffic information X(1) to X(M) about the links 1 to M is given a weight of “1” for links for which the traffic information has been collected, and given a weight of “0” for links for which no traffic information has been collected. The weighted projection of X onto the linear space formed of the bases W(1) to W(P) is performed as

Traffic Information X=a(1)×W(1)+a(2)×W(2)+ . . . +a(P)×W(P)+e (Formula 4),

which gives the weighting coefficients a(1) to a(P) that minimize the norm of an error vector e for the links for which the traffic information has been collected. Besides the two values “1” and “0” based on the presence or absence of the traffic information, the weights on the links may be determined in other ways such as based on the reliability or recency of the collected probe traffic information. For example, the weights based on the reliability may be determined by the number of floating cars that passed through the road links. If one floating car passed through the link 1 and three floating cars passed through the link 2, the weight for the link 2 may be set to be three times that for the link 1 so that the reliability is reflected on the weights. If the weights are determined based on the recency of the probe traffic information, a large weight is set for the link travel time data collected at the latest time with respect to the time of processing in the traffic information reconstruction unit 60.

From the vector of the bases W(1) to W(P) and the weighting coefficients a(1) to a(P), a vector of the reconstructed traffic information X′=[x′(1), x′(2), . . . , x′(M)] is computed with

X′=a(1)×W(1)+a(2)×W(2)+ . . .+a(P)×W(P) (Formula 5),

where x′(i) denotes the traffic information reconstructed with Formula 5 for the ith link. The traffic information here can be replaced with the real-time traffic information and the historical traffic information.

To generate the reconstructed traffic information data using a vector of bases W′(1) to W′(P) that takes into account the statistical traffic information when the bases are generated, weighted projection of a vector of the data in question X2=[X,T] that consists of the vector of the traffic information X and the vector of the statistical traffic information T about the links 1 to M is performed onto the bases W′(1) to W′(P). At this point, the traffic information X(1) to X(M) about the links 1 to M is given a weight of “1” for links for which traffic information has been collected, and given a weight of “0” for links for which no traffic information has been collected. The statistical traffic information T(1) to T(M) about the links 1 to M is given a weight of “1”. Then, the weighted projection of X2 is performed onto the bases W′(1) to W′(P) as

X2=a2(1)×W′(1)+a2(2)×W′(2)+ . . .+a2(P)×W′(P)+e (Formula 6),

which gives weighting coefficients a2(1) to a2(P) that minimize the norm of an error vector e for the links for which traffic information has been collected. Besides the two values “1” and “0” based on the presence or absence of the traffic information, the weights for the links of the statistical traffic information may be determined in other ways such as based on the freshness of the statistical traffic information, the number of samples, and son on.

From the vector of the bases W′(1) to W′(P) and the weighting coefficients a2(1) to a2(P), a reconstructed vector of the data in question X2′=[x′(1), x′(2), . . . , x′(M), t′(1), t′(2), . . . , t′(M)] is computed with

X2′=a2(1)×W′(1)+a2(2)×W′(2)+ . . . +a2(P)×W′(P) (Formula 7),

where x′ denotes the traffic information reconstructed with Formula 7 for the M links, and t′ denotes the statistical traffic information reconstructed with Formula 7 for the M links. In the following processing, the reconstructed traffic information is used. Therefore, for the reconstructed vector of the data in question X2′, it is assumed that a vector of the extracted first to Mth elements corresponding to the traffic information is the reconstructed traffic information X′.

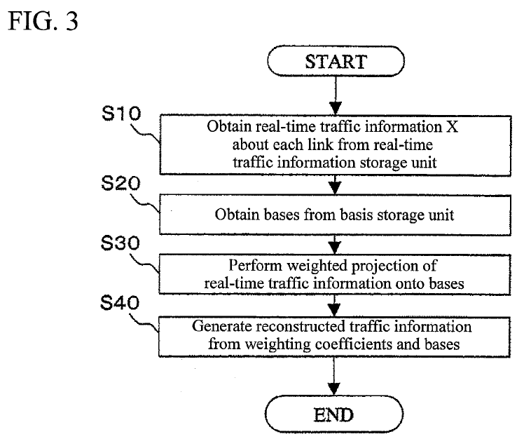

In the online processing, the real-time reconstructed traffic information is computed in the traffic information reconstruction unit 60. The real-time reconstructed traffic information is the result of using the bases obtained in the basis computation unit 40 to reconstruct the traffic information observed in real time. FIG. 3 shows a processing flow of reconstructing the real-time data in the online processing. First, the real-time traffic information X about each link included in a map mesh to be processed is obtained from the real-time traffic information storage unit 20 (step S10). Next, the top bases W(1) to W(P) corresponding to the number of a second-order mesh to be analyzed are obtained from the basis storage unit 50 (step S20). Next, based on the obtained bases, the weighted projection of the real-time traffic information is performed so that the norm of the error vector e in Formula 4 is minimized (step S30). Based on the weighting coefficients a(1) to a(P) corresponding to the top bases out of the weighting coefficients obtained by this weighted projection, the reconstructed traffic information X′ is obtained using Formula 5, and the traffic information reconstructed for each link is output (step S40). With the above processing flow, the real-time reconstructed traffic information is generated.

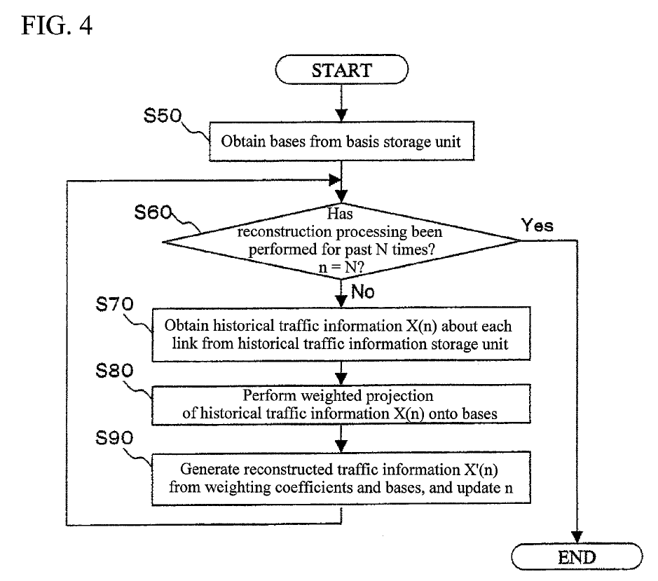

In the offline processing, the historical reconstructed traffic information is computed in the traffic information reconstruction unit 60. The reconstructed traffic information based on the historical traffic information is reconstructed traffic information for N times at the past N collection timings. Therefore, the reconstructed traffic information is generated for collected sample data for N times. FIG. 4 shows a processing flow of reconstructing the historical traffic information in the offline processing. This is the same as the processing of computation for obtaining the reconstructed traffic information shown in FIG. 3 repeated for the traffic information for N times. First, as initialization processing, the top bases W(1) to W(P) corresponding to the number of a second-order mesh to be analyzed are obtained from the basis storage unit 50, and n is set to be 1 (step S50). Next, it is determined whether the traffic information reconstruction processing has been performed for all (N items of) sample data of the historical traffic information (step S60). If the processing has been performed for all sample data (Yes in step S50), the processing terminates. If the processing has not yet been performed for all samples (No in step S60), the historical traffic information X(n) about each link for the nth sample data is obtained from the historical traffic information storage unit 30 (step S70). Based on the bases W(1) to W(P), the weighted projection of the historical traffic information X(n) is performed. The weighting coefficient for each basis is computed with this weighted projection (step S80), and Formula 5 is used to generate the reconstructed traffic information X′(n) based on the bases W(1) to W(P) and the weighting coefficients a(1) to a(P). Further, n is updated by adding 1 to n (step S90), and the flow returns to the determination processing in S60. With the above processing flow, the reconstructed traffic information for the historical traffic information is generated with all sample data for N times.

The difference computation unit 70 computes the difference (difference traffic information) between the traffic information input to the traffic information reconstruction unit 60 and the reconstructed traffic information output from the traffic information reconstruction unit 60. In the online processing, the difference between the real-time reconstructed traffic information output from the traffic information reconstruction unit 60 and the real-time traffic information stored in the real-time traffic information storage unit 20 is computed. In the offline processing, the difference traffic information for N times between the reconstructed traffic information for past N times output from the traffic information reconstruction unit 60 and the historical traffic information for past N times stored in the historical traffic information storage unit 30 is computed. This difference traffic information is the difference between the link travel time for each link in the reconstructed traffic information and the link travel time for each link in the traffic information corresponding to the reconstructed traffic information. If the value of the output difference traffic information is large, it means that the information about the links in the mesh in question cannot be represented with the top bases stored in the basis storage unit 50. Conversely, it can be said that the correlation among the links in the mesh in question is corrupted compared with the historical traffic information. The bases represent the correlation among the links in the mesh in question. Therefore, in the present invention, the traffic information about a road link that cannot be represented by the correlation extracted from the historical traffic information data is detected as an unexpected incident.

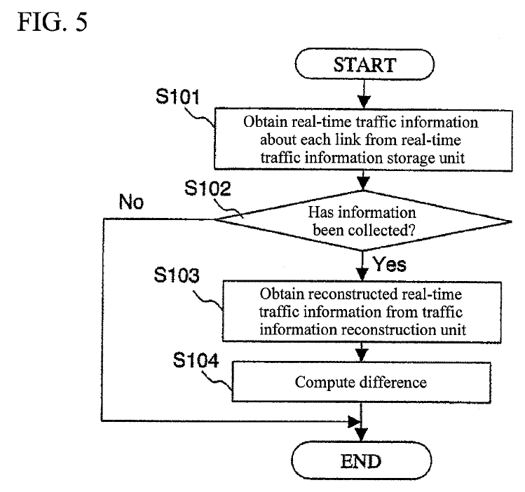

FIG. 5 is a diagram showing an overview of a processing flow for the real-time traffic information in the difference computation unit 70 according to this embodiment. As shown in FIG. 5, the difference between the real-time reconstructed traffic information X′ computed by the traffic information reconstruction unit 60 and the traffic information X stored in the real-time traffic information storage unit 20 is determined. That is, the difference between the traffic information about the links 1 to M in the real-time traffic information X and the traffic information about the links 1 to M in the reconstructed traffic information X′ is determined for each link. The difference computation processing is processing performed for all links. The processing flow will be specifically described below with reference to FIG. 5. For the real-time traffic information stored in the real-time traffic information storage unit 20, the traffic information about each link is obtained (step S101). Here, description will be given for the case of the ith link. In actual processing, all links 1 to M will be processed. For the obtained real-time traffic information X(i) about the link i, it is determined whether the information has been collected without loss (step S102). If the real-time traffic information is generated based on probe data, there are road links for which the traffic information has been able to be collected and road links for which the traffic information is missing (no traffic information has been collected). To compute the difference between the real-time reconstructed traffic information and the real-time traffic information, the traffic information about the road link in question must have been measured. If the real-time traffic information X(i) about the link i is missing (No in step S102), the processing for the link i terminates. If the real-time traffic information about the link i has been able to be collected (Yes in step S102), the real-time reconstructed traffic information X′(i) about the link i is obtained from the traffic information reconstruction unit 60 (step S103). Next, the difference between the obtained real-time traffic information X(i) and reconstructed traffic information X′(i) is determined. The difference traffic information d(i) about the link i is computed (step S104) as

d(i)=X(i)−X′(i) (Formula 8),

and the processing for the link i terminates. The above processing is performed for all links 1 to M. In this manner, a vector of the difference traffic information for the real-time traffic information D=[d(1), d(2), . . . , d(M)] can be generated. For the difference d(i) of the link i determined as No in step S102, a unique value that allows the value of the real-time traffic information X(i) to be identified as missing is defined, so that a value, for example NaN (Not a Number), is assigned to the difference d(i).

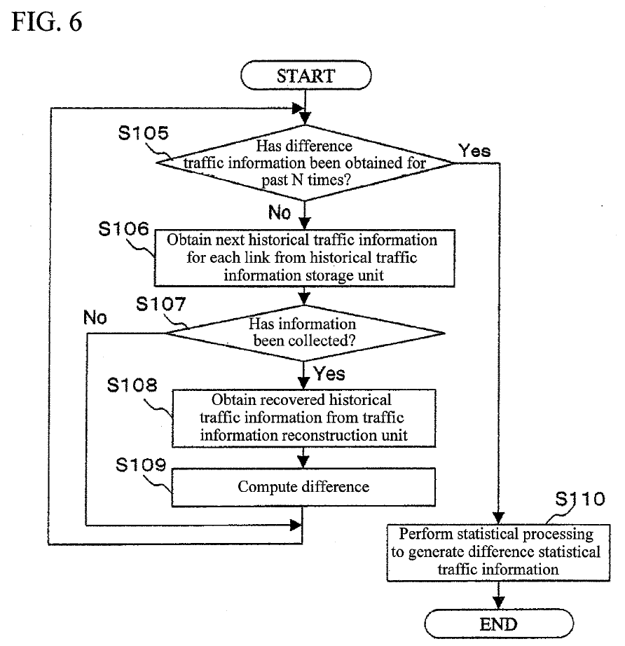

In the offline processing, since the historical reconstructed traffic information has been computed for N times, the difference traffic information is also computed for N times. FIG. 6 shows this processing flow. First, it is determined whether the difference traffic information has been obtained for all (N items of) sample data of the historical traffic information (step S105). If all reconstructed traffic information has been processed (Yes in step S105), the flow proceeds to step S110. If not all reconstructed traffic information has been processed (No in step S105), the following loop processing is performed. First, for the historical traffic information at the next collection timing following the previous loop processing, the traffic information about the links 1 to M is obtained from the historical traffic information storage unit 30 (step S106). Next, as in step S102 of FIG. 5, it is determined for each of all obtained links whether the traffic information has been collected or is missing (step S107). If the traffic information about the link is missing (No in step S107), the flow proceeds to step S105. If the traffic information about the link has been collected (Yes in step S107), then, from the traffic information reconstruction unit 60, the traffic information about this link is obtained from the reconstructed historical traffic information at the collection timing currently being processed. Next, the difference between the historical traffic information and the reconstructed historical traffic information at the same collection timing is computed (step S109). By performing the processing from step S107 to step S109 for all links 1 to M, the difference traffic information at the collection timing currently being processed is obtained. Next, the flow proceeds to step S105 to continue with the loop processing for the next collection timing.

After obtaining the difference traffic information for the N collection timings, in step S110, the historical difference traffic information is statistically processed to generate difference statistical traffic information. For example, based on time-series data of the difference traffic information about each link for past N times, statistical processing is performed according to what is called the day factors such as weekday and holiday, and the times of day. Then, the difference statistical traffic information such as the maximum value, average value, and standard deviation of differences at the same time of day is generated.

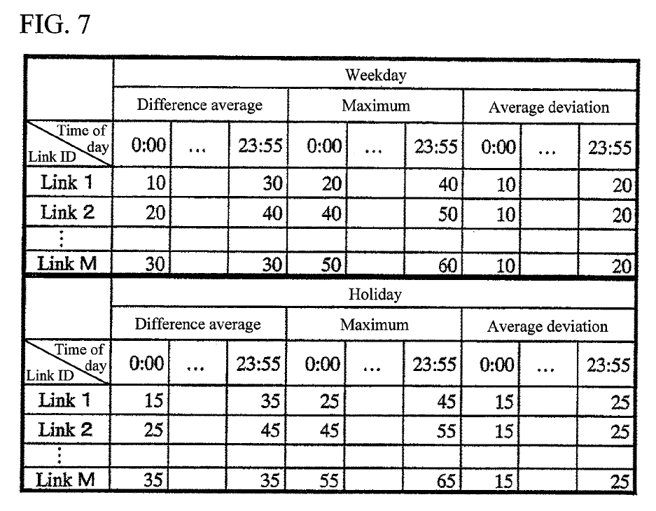

The difference statistical traffic information storage unit 80 stores the difference statistical traffic information generated in the difference computation unit 70. FIG. 7 is a diagram showing a structure of the difference statistical traffic information stored in the difference statistical traffic information storage unit 80. The difference statistical traffic information in the difference statistical traffic information storage unit 80 is accumulated in the offline processing; the difference statistical traffic information generated from the difference traffic information for N times output from the difference computation unit 70 is accumulated. This difference statistical traffic information is classified according to what is called the day factors such as weekday and holiday and statistical information such as the maximum value, difference average value, and standard deviation, and it is managed with link IDs of road links on a time-of-day basis. Here, it is assumed that the link ID of the ith road link is “Link i”.

The unexpected incident determination unit 90 compares the difference traffic information about the real-time traffic information output from the difference computation unit 70 with the difference statistical traffic information stored in the difference statistical traffic information storage unit 80, and determines the occurrence of an unexpected incident. The unexpected incident determination unit 90 aims to compare the difference traffic information with the difference statistical traffic information and recognize that the correlation of the traffic information among the links in a mesh in question is corrupted. For this purpose, the traffic information reconstruction unit 60 first takes, as its input, the real-time traffic information about the whole area in which detection of an unexpected incident is intended, and converts it into the link-based reconstructed traffic information. The difference computation unit 70 then computes the difference between this reconstructed traffic information and the real-time traffic information. Then, a determination is made as to the traffic information correlation.

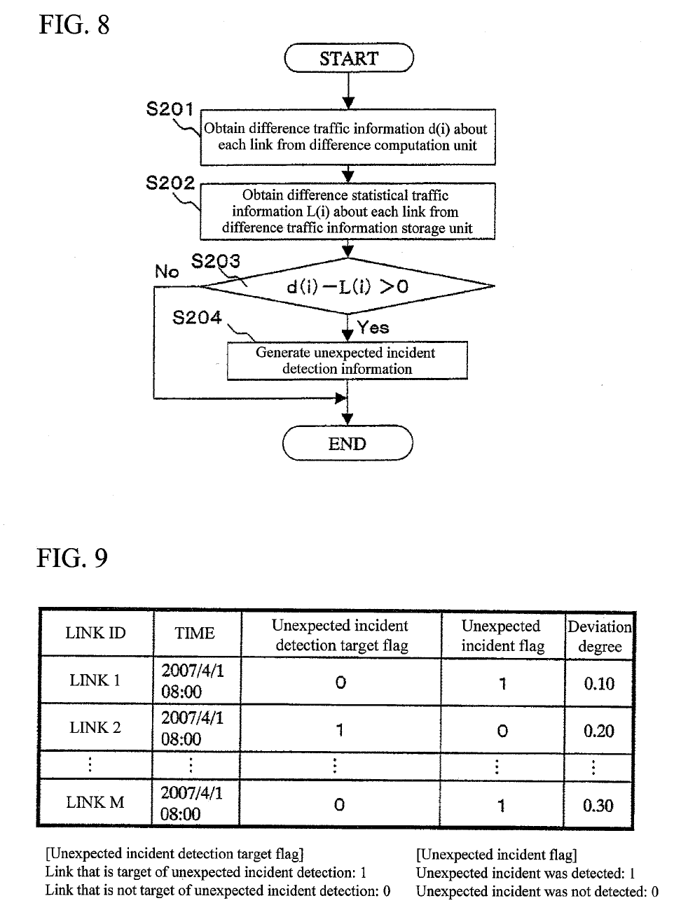

The unexpected incident determination unit 90 detects an unexpected incident for each link based on whether the difference traffic information output from the difference computation unit 70 is relatively large compared with a threshold generated from the difference statistical traffic information storage unit 80. For example, this threshold is the maximum value at each time of day stored in the difference statistical traffic information storage unit 80. In the difference statistical traffic information shown in FIG. 7, a threshold L(i) for the link i is the maximum value for the corresponding link ID in the classification of the day factor and the time of day corresponding to the date and time at which detection of an unexpected incident is intended. FIG. 8 is a diagram showing an overview of a processing flow in the unexpected incident determination unit 90 in the center apparatus 1 according to this embodiment. The processing flow of determining an unexpected incident will be described for the ith link. The ith difference traffic information d(i) is obtained from the difference traffic information output from the difference computation unit 70 (step S201). Next, from the difference statistical traffic information of the same day factor stored in the difference statistical traffic information storage unit 80, the maximum value of the difference statistical traffic information on a time-of-day in question is obtained as the threshold L(i) (step S202). Next, the obtained difference traffic information d(i) is compared with the threshold L(i) (step S203). If d(i)−L(i)>0 (Yes in step S203), the obtained difference traffic information is larger than the threshold. Therefore, it is determined that an unexpected incident is occurring on this link i, and unexpected incident detection information is generated (step S204). On the other hand, if d(i)−L(i)≦0 (No in step S203), the difference traffic information is smaller than the threshold. Therefore, it is determined that it is within the range of an expected incident, and the processing for the ith link terminates. The above processing is repeated for the road links in the area being processed. For road links for which the value of the current traffic information is missing, the comparison with the difference statistical traffic information is not performed. The threshold L(i) may also be determined by using an average value M(i) and a standard deviation STD(i) of the difference statistical traffic information at the time-of-day in question in the difference statistical traffic information of the same day factor stored in the difference statistical traffic information storage unit 80. Where k denotes a coefficient, the threshold L(i) can be determined with the following equation.

L(i)=M(i)+k+STD(i)

Assuming that the difference statistical traffic information is a normal distribution, the threshold L(i) is a value less likely to occur with a probability of about one third of the whole difference statistical traffic information when the coefficient k is 1, and with a probability of about three thousandths when the coefficient k is 3.

The processing in the unexpected incident determination unit 90 is performed each time a new current-state value is collected. Therefore, it may be determined that “an unexpected incident is occurring” if the determination processing continuously results in d(i)−L(i)>0 for several times. This can increase the reliability of the determination. FIG. 9 is a diagram showing a structure of the unexpected incident detection information generated in step S204. The unexpected incident detection information consists of the link ID, the time at which an unexpected incident was detected by the comparison of the difference with the threshold, an unexpected incident detection target link flag, an unexpected incident occurrence flag, and the deviation degree from the threshold.

The unexpected incident detection target link flag is for determining whether the link is a target of the unexpected incident detection. The value 1 indicates that it is a target of the unexpected incident detection, and 0 indicates that it is not a target. In the processing of the present invention, the real-time traffic information is compared with the traffic information reconstructed using the real-time data. Therefore, a road link with data loss due to the lack of the real-time traffic information data does not become a target link of the unexpected incident detection. As such, the result of determination in step S102 of FIG. 5 is saved. The unexpected incident occurrence flag indicates whether the link in question is identified as having an unexpected incident. This reflects the result of step S203 of FIG. 8, so that it is set to be 1 if the processing step S203 for determining an unexpected incident results in Yes, or 0 if the step S203 results in No. Further, the deviation degree is defined as (d(i)−L(i))/L(i), which is the ratio of the difference between the difference traffic information d(i) and the threshold L(i) to the threshold L(i). This represents how significant the deviation of the real-time traffic information compared to the threshold is. Therefore, the larger the deviation degree is, the higher the reliability of the unexpected incident detection is. Further, it can be said that the scale of the unexpected incident is also larger.

The above processing is performed for all links. The obtained unexpected incident detection information is output to the traffic information transmission unit 100. The traffic information transmission unit 100 transmits the unexpected incident detection information output from the unexpected incident determination unit 90 to each on-board terminal apparatus 110.

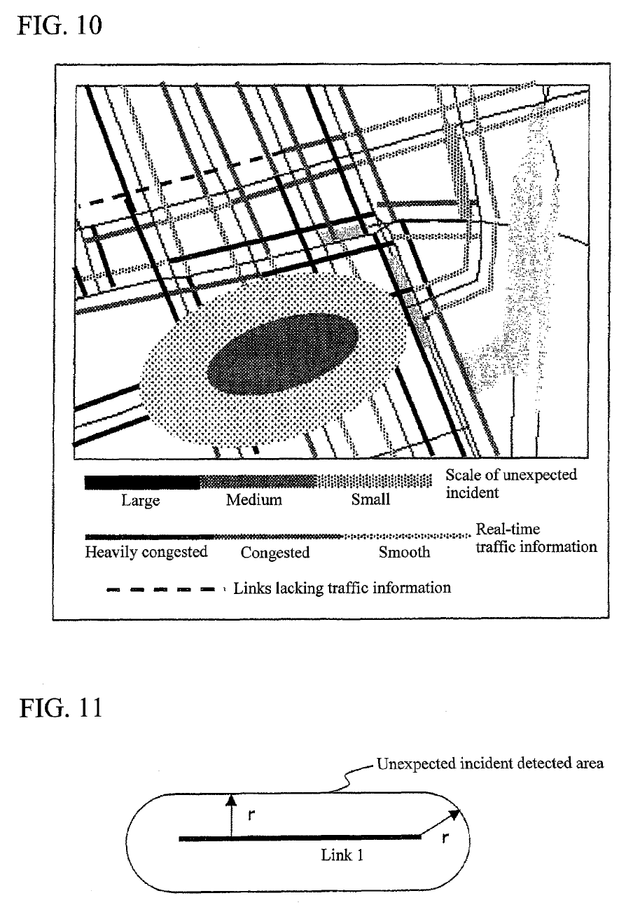

The on-board terminal apparatus 110 receives the unexpected incident detection information from the traffic information transmission unit 100 and displays the received unexpected incident detection information. FIG. 10 is a diagram showing an exemplary display of the unexpected incident detection information on the on-board terminal apparatus 110. The real-time traffic information, links for which an unexpected incident has been detected, and links for which the real-time traffic information is missing, are distinguished by the thickness of lines of road links. Also, the unexpected incident is evaluated as a large, medium, or small level according to the congestion degree of the road links and the scale of the unexpected incident, and the scale of the unexpected incident is displayed with varying colors. The scale of the unexpected incident is generated from the deviation degree stored in the unexpected incident detection information in FIG. 9. For distinction among the real-time traffic information, the links for which an unexpected incident has been detected, and the links for which the real-time traffic information is missing, display techniques may be used such as changing the hue, saturation, or brightness of the lines, changing the line type, and so on.

Further, an unexpected incident detected area according to the deviation degree is generated from a link for which an unexpected incident has been detected, and a region around this link is displayed. FIG. 11 is a diagram showing a concept of the unexpected incident detected area for the link 1 for which the occurrence of an unexpected incident has been detected. The distance r from the link 1 is determined from the deviation degree of the unexpected incident detection information. If a plurality of unexpected incident detected areas overlap, an area with the highest deviation degree takes priority to be displayed. Therefore, for the link 1 and link 2 for which an unexpected incident has been detected, if the link 1 has a large deviation degree and the link 2 has a medium deviation degree and their unexpected incident detected areas overlap, the unexpected incident detected area for the link 1 takes preference to be displayed.

According to the above-described embodiments, an unexpected incident can be automatically detected only with limited information, i.e., the link travel time. A characteristic of the unexpected incident detection of the present invention is to recognize the situation in which the correlation of road traffic information in a mesh in question is corrupted compared to the past. Further, the unexpected incident information can be distributed based on the position information and time information about where and when the unexpected incident information has been detected, its scale, and its reliability. Distributing this information to the on-board terminal apparatuses 110 enables a service useful for the drivers' decision making.

What is claimed is:

1. A traffic information system that detects the presence or absence of an unexpected incident on a road link based on externally provided traffic information, comprising:
a traffic information storage unit that accumulates the traffic information;
a statistical computation unit that generates correlation information among road links about traffic information by statistical analysis for historical traffic information stored in the traffic information storage unit;
a traffic information reconstruction unit that determines traffic information reconstructed using the correlation information so that an error relative to input traffic information is minimized;
a difference computation unit that determines a difference between the traffic information input to the traffic information reconstruction unit and the reconstructed traffic information reconstructed for the input traffic information by the traffic information reconstruction unit; and
an unexpected incident determination unit that determines the presence or absence of an unexpected incident, wherein
the traffic information reconstruction unit determines real-time reconstructed traffic information reconstructed for currently provided traffic information, and historical reconstructed traffic information reconstructed for the historical traffic information stored in the traffic information storage unit,
the difference computation unit determines a first difference that is a difference for each road link between the currently provided traffic information and the real-time reconstructed traffic information, and a second difference that is a difference for each road link between the historical traffic information stored in the traffic information storage unit and the historical reconstructed traffic information,
the unexpected incident determination unit determines the presence or absence of an unexpected incident for each road link by comparing the first difference with a threshold defined based on the second difference, and
determined unexpected incident information is distributed to an on-board terminal.

2. The traffic information system according to claim 1, wherein
the correlation information is bases representing a multiple link correlation principal obtained by component analysis for the historical traffic information about each road link, and
the traffic information reconstruction unit reconstructs the traffic information using top bases having a high proportion out of the bases.

3. The traffic information system according to claim 2, wherein
the traffic information reconstruction unit determines the reconstructed traffic information for the input traffic information by linear combination of the bases and weighting coefficients obtained by performing projection of the input traffic information onto a feature space formed of the bases.

4. The traffic information system according to claim 1, wherein the unexpected incident information comprises flag information indicating the presence or absence of an unexpected incident for each road link, and deviation degree information indicating a value of the first difference.

5. The traffic information system according to claim 4, wherein the on-board terminal receives the deviation degree information in the unexpected incident information and displays a road link corresponding to an unexpected incident with a line of varying hue, saturation, or brightness according to the deviation degree information so that the scale of the unexpected incident is represented according to the deviation degree information.

6. The traffic information system according to claim 2, wherein
the difference computation unit computes difference statistical traffic information obtained by statistically processing the second difference, and
the threshold is defined based on the difference statistical traffic information.

7. The traffic information system according to claim 6, wherein the difference statistical traffic information is information in which time-series traffic information data of the second difference is classified by a day factor including classification of weekday and holiday, and for each class of the day factor, statistical values including an average value, a standard deviation, and a maximum value at the same times of day are determined.
